(19) United States
(12) Patent Application Publication
(10) Pub. No.: US 2013/0205290 A1
(43) Pub. Date: Aug. 8, 2013

(54) METHOD TO AUTOMATICALLY UPDATE A CONTROL AND PROCESSING PROGRAM

(71) Applicant: Maria Kroell, Erlangen (DE)

(72) Inventor: Maria Kroell, Erlangen (DE)

(21) Appl. No.: 13/760,625

(22) Filed: Feb. 6, 2013

(30) Foreign Application Priority Data
Feb. 7, 2012 (DE) 102012201785.2

(51) Int. Cl. G06F 9/445

(52) U.S. Cl. CPC G06F 8/65
USPC 717/171

(57) ABSTRACT

In a method and medical examination apparatus to automatically update a control and processing program at a terminal apparatus that is provided to process examination information obtained by the medical examination apparatus and to control an examination program at the medical examination apparatus, the examination program is updated at the examination apparatus, update information is transmitted from the examination apparatus to the terminal apparatus, the control and processing program is updated at the terminal apparatus depending on the update information.

### BACKGROUND OF THE INVENTION

1. Field of the Invention

The present invention concerns a method to automatically update a control and processing program that is provided for processing examination information obtained by a medical examination apparatus, and to control an examination program at the medical examination apparatus, as well as a medical examination system and non-transitory, computer-readable data storage medium encoded with programming instructions, to implement such a method.

2. Description of the Prior Art

Medical examination systems often include a technical examination apparatus with a data processing device that controls a medical examination on a patient or an organism with the use of software or data processing programs. For example, different scan programs that respectively produce a defined control of the magnetic resonance scanner (MR scanner) are executed to examine a patient at the MR scanner. In an MR scanner, for example, the scan programs control the coils arranged in the MR scanner in order to acquire different examination data and examination results, for example data about a spin-spin relaxation or a spin-grid relaxation of a tissue.

The reading and evaluation of these different scan data are normally implemented at an terminal apparatus for a user with data processing functionality, at which terminal apparatus a program runs for processing and displaying the acquired scan data. For this purpose, the scan data are transferred from the MR scanner to the terminal apparatus. For example, comparisons of different examination data sets (of different scan contrasts, for example) are implemented in order to base a diagnosis on the comparison. Given programs with predefined processing workflows for multiple examination data sets, an automatic structuring of data in layouts or views can be provided. In addition to a processing of the acquired data, the terminal apparatus of the examination apparatus can be prompted to implement a selected examination.

If the scan programs are now changed at the MR scanner and adapted to the newest developments, the original, automatic structuring of data in layouts can lead to incorrect results, or can no longer be used. Depending on the extent of the update, the preset structurings of data in layouts increasingly lose their utility.

The manual adaptation of a processing workflow guideline or structuring of the medical data is time-consuming—in particular the adaptation of MR processing workflows to changing scan programs, since the scan data must often be sought from a long list of available scan results. This procedure is time-consuming and error-prone since MR scans can be overlooked due to manual loading and sorting, and this is not part of the actual radiological task of an evaluation of MR images and posing a diagnosis. In many cases, a clinical administrator who is responsible for the updating of the programs at the terminal apparatus does not even have knowledge of the modified scan programs at the MR scanner since the update is not indicated in any way.

### SUMMARY OF THE INVENTION

An object of the invention is to remedy the tendency of the conventional procedure described above toward error.

According to one aspect, the object according to the invention is achieved by a method to automatically update a control and processing program at an terminal apparatus that is provided to process an examination information obtained by a medical examination apparatus and to control an examination program at said medical examination apparatus, that includes the steps of updating the examination program at the examination apparatus, transmitting update information from the examination apparatus to the terminal apparatus, and adapting the control and processing program at the terminal apparatus depending on the update information.

For example, the technical advantage is achieved that the control and processing program at the terminal apparatus is informed about an update of examination programs at the examination apparatus, and therefore can halt the control and processing of examination data at the terminal apparatus with this update step. Errors in the processing of the examination data or in a control of the examination apparatus due to outdated programs are thereby avoided.

The terminal apparatus is a data processing apparatus that is in the position to obtain defined output data from given input data based on a program or a processing rule. The terminal apparatus is a part of a user interface for a user via which said user can communicate with the terminal apparatus. For example, via the user interface a user can input data into the terminal apparatus or visualize data. For example, the terminal apparatus can be a computer terminal, a workstation, a personal computer or a server.

The control and processing program is a work instruction or a series of elementary work instructions for a data processing system to achieve a defined control or processing job. The control or processing program can be composed in a programming language and can subsequently be translated into a machine code suitable for the terminal apparatus. The control job according to the invention includes a control of an examination apparatus by setting, modifying or receiving states. In particular, the control at the terminal apparatus can retrieve individual programs or sub-programs at the examination apparatus. The processing job includes the data processing of data that have been acquired by the examination apparatus.

As used herein, a program is any sequence of instructions satisfying the rules of a programming language, which instructions can be executed at a computer or a data processing system in order to therefore provide a defined functionality.

The examination apparatus is an apparatus for the technical implementation of a medical examination. The examination apparatus comprises a data processing system to control a technical workflow of the medical examination via an examination program. For example, the examination apparatus can be a computer tomography apparatus, a magnetic resonance apparatus, an x-ray apparatus, a radiation therapy apparatus, a positron emission tomography apparatus, an ultrasound apparatus or another apparatus to implement a medical treatment or examination. By executing the examination program, the examination apparatus is in the position to acquire medical data of a person or an organism. For example, such data can include image information or be converted into image information.

The examination program runs on the data processing system of the examination apparatus and controls the technical workflows of the medical examination in order to acquire the desired data. In the case of an MR scanner, for example, the examination program includes programs to control electromagnetic or magnetic fields generated inside the MR scanner by coils.

The updating of the examination program can include a complete or partial modification or replacement of the examination program, for example in order to modify a control workflow at the examination apparatus.

The transmission of update information comprises the sending or transmission of data from the examination apparatus to the terminal apparatus, for example electronically or optically via wires or cables, or wirelessly. For example, the update information can be a single bit that indicates an update of the examination program; an identification information that additionally indicates which modifications have been made to the examination program; or a version information that associates a version number with the examination program. The update information can also be a program, for example, that is transmitted from the examination apparatus to the terminal apparatus and is subsequently executed at the terminal apparatus in order to implement the adaptations of the control and processing program.

The adaptation of the control and processing program includes a complete or partial modification or replacement of the control and processing program on the basis of the transmitted update information, for example in order to modify a control and processing workflow at the examination apparatus.

In an embodiment, the examination program has multiple sub-programs, and the step of updating the examination program comprises the step of updating a sub-program within the examination program; a removal of a sub-program from the examination program; and/or an addition of a sub-program to the examination program.

For example, through the use of sub-programs the technical advantage is achieved that individual sub-programs can be combined into more complex units made up of multiple sub-programs. By the use of redundant code, the technical advantage results that the size of the stored examination program in a memory is reduced. In addition, the technical advantage results that the examination program can be updated in a simple technical manner in that only individual sub-programs of the plurality of sub-programs are replaced or modified. This procedure additionally saves time and energy in an updating process, such that this can be executed more efficiently.

In a further embodiment, a unique identification information is associated with the sub-program, and the step of transmitting update information includes the step of a transmission of the identification information. This achieves the technical advantage that the terminal apparatus receives a transmission of a unique identification information for each sub-program at the examination apparatus, and the control and processing program can adapt highly exactly and precisely to each individual sub-program at the examination apparatus.

In a further embodiment, the control and processing program includes multiple sub-programs that are associated with a processing workflow guideline, and the step of adapting the control and processing program comprises the step of updating a sub-program in the processing workflow guideline; a removal of a sub-program from the processing workflow guideline; and/or an addition of a sub-program to the processing workflow guideline depending on the update information. This achieves the technical advantage that a sub-program for control and processing at the terminal apparatus can be associated with each sub-program at the examination apparatus, and the technical cost for an adaptation of the control and processing program at the terminal apparatus is reduced. In addition to this, the technical advantage arises that a creation of redundant code is avoided via a combination of individual sub-programs into processing workflow guidelines. The processing workflow guideline combines the control and processing of multiple sub-programs into one more complex process.

In a further embodiment, the method includes the step of storing a provided association between a sub-program of the examination program and a sub-program of the control and processing program. This achieves the technical advantage that a number of specific sub-programs of the examination program can be associated with each processing guideline at the terminal apparatus, and the amount of data for an association is reduced.

In a further embodiment, the method includes the step of adapting a display program at the terminal apparatus depending on the update information. This achieves the technical advantage that not only a control and processing but rather also a display of image information is adapted to the modifications at the examination apparatus, and acquired information can be displayed optimally (for example with a higher resolution).

The display program is a job instruction at the data processing apparatus in order to bring acquired examination data into a form that is readable or recognizable by humans, and can include a Fourier transformation, for example.

In a further embodiment, the method includes the step of characterizing a sub-program of the examination program as a standard sub-program. This achieves the technical advantage that an information is provided that allows a differentiation between standard programs and non-standard programs, and that can serve as a basis for an additional increase of the efficiency of the method.

In a further embodiment, the method includes the step of transmitting the update information for the standard sub-program to the terminal apparatus. By transmitting update information for only standard sub-programs, the technical advantage is achieved that the amount of update information between examination apparatus and terminal apparatus is reduced, such that the update information can be transmitted more quickly.

According to a further aspect, the object according to the invention is achieved by a medical examination system with an examination apparatus that is operable to obtain examination information by execution of an examination program, and a processing apparatus to control the examination apparatus by execution of a control program and to process the obtained examination information, with the examination system being configured to implement the method according to the invention. The same technical advantages can be achieved as with the method according to the invention.

The above object also is achieved in accordance with the present invention by a non-transitory, computer-readable data storage medium encoded with programming instructions that, when the programming instructions are distributed between a computerized processor that controls and operates a medical examination system according to an examination program, and a terminal apparatus at which examination data obtained by the medical examination system are processed, cause the control unit and the terminal apparatus to implement any or all embodiments of the method as described above.

### BRIEF DESCRIPTION OF THE DRAWINGS

FIG. 1 schematically illustrates a medical examination system with an MR scanner.

FIG. 2 schematically shows the design of a scan program at an MR scanner in accordance with the invention.

FIG. 3 schematically shows a design of a control and processing program at a terminal apparatus in accordance with the invention.

FIG. 4 schematically shows a transmission of update information between an MR scanner and the terminal apparatus in accordance with the invention.

FIG. 5 is a block diagram for the adaptation of a control and processing program in accordance with the invention.

### DESCRIPTION OF THE PREFERRED EMBODIMENTS

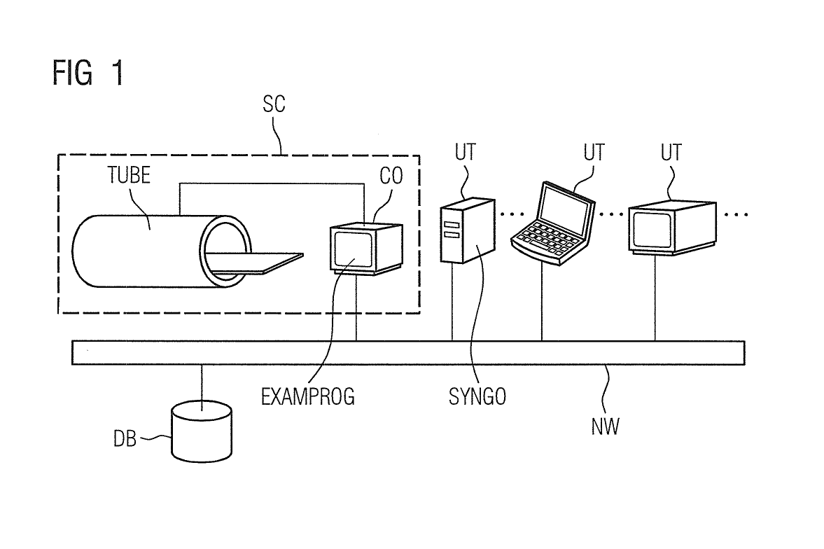

FIG. 1 shows a magnetic resonance scanner (MR scanner) SC that is representative of a medical examination apparatus, and multiple terminal apparatuses UT. Each of the terminal apparatuses UT forms at least a part of a control panel that is engaged in a data exchange with the MR scanner SC via a network NW.

To control the technical workflow of a medical examination, and to store and process acquired examination data, the magnetic resonance scanner SC has a programmable control system CO on which a control program EXAMPROG runs during an examination. For example, the control system CO can be formed by a computer, for example a workstation, a personal computer or another data processing and control unit on which software for technical implementation of the medical examination can be used. The control system CO can therefore likewise be formed by a circuit board with a processor inside the MR scanner SC.

In principle, it is possible to have the control jobs executed by multiple control systems CO, or to control multiple MR scanners SC with one control system CO. The control system CO shown in FIG. 1 has a display. In an alternative embodiment, however, the display can be omitted.

For an MR examination, suitable coil elements of an examination tube TUBE (for example) are selected by the control system CO that are individually aligned towards and arranged on the patient. These coils are activated by the control system CO via a pulse program or scan program EXAMPROG so that electromagnetic fields provided inside the MR scanner SC are generated.

In the method to control the MR scanner, a database DB can be resorted to in which data and parameters are stored that are relevant to the control of the MR scanner SC.

The control program EXAMPROG running on the control system CO, or individual sub-programs of the control program EXAMPROG, can in turn be called by the control panel at the terminal apparatus UT and be controlled by these so that a user can initiate, affect and control the medical examination via said control panel. For example, the terminal apparatus UT can be a workstation, a laptop or a personal computer.

Through a control and processing program SYNGO of the terminal apparatus UT, a user can enter data for the control of the MR scanner SC that serve to control the MR scanner SC via the control system CO. In addition, the terminal apparatus UT serves to process examination data received from the MR scanner SC and prepare the examination data for a graphical presentation (for example through a Fourier transformation) so that the examination data can be displayed in an understandable manner at a display device. For example, a virtual MR scanner that simulates the respective real MR scanner SC is implemented at the terminal apparatus UT for control of said MR scanner SC.

In a medical examination, the control and processing program SYNGO at the terminal apparatus UT thus controls the examination program EXAMPROG at the MR scanner SC, which in turn controls the technical workflow of the medical examination. The examination data acquired by the MR scanner SC are then returned [sic] via the control system CO to the terminal apparatus UT and there are processed by the control and processing program SYNGO.

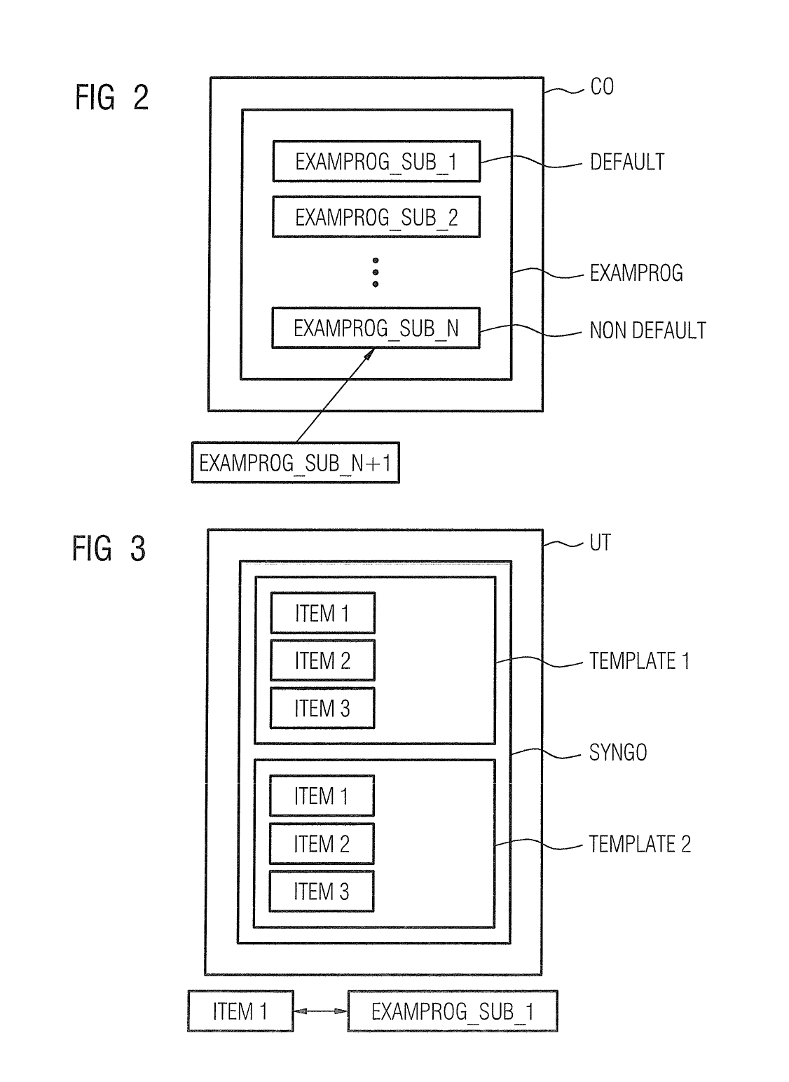

FIG. 2 shows a schematic view of the design of a scan program EXAMPROG at a control system CO of an MR scanner SC.

The examination system EXAMPROG at the MR scanner SC can include a number of sub-programs EXAMPROG_SUB that respectively implement a specific sub-examination and can be called up individually.

For example, a first sub-program EXAMPROG_SUB_{—}1 can be provided at the MR scanner SC to implement a spin-grid relaxation measurement while a second sub-program EXAMPROG_SUB_{—}2 is provided to implement a spin-spin relaxation measurement. In particular in the field of magnetic resonance examinations, a plurality of different sub-programs EXAMPROG_SUB_N can be used that respectively take into account a specific technical examination aspect.

FIG. 3 shows a schematic view of a design of a control and processing program SYNGO at the terminal apparatus UT and an association between a sub-program ITEM1 of the control and processing program SYNGO and a sub-program EXAMPROG_SUB_{—}1 of the scan program EXAMPROG.

In the same manner, the control and processing program SYNGO at the terminal apparatus UT can include a number of sub-programs ITEM that are respectively logically linked with one or more sub-programs EXAMPROG_SUB at the MR scanner SC and that respectively serve for the retrieval and control of the sub-programs EXAMPROG_SUB at the MR scanner SC, and for the preparation of the data acquired by the individual sub-programs.

The sub-programs EXAMPROG_SUB at the MR scanner can be called in a defined and specific manner via the sub-program ITEM at the terminal apparatus UT in order to respectively, optimally receive examination data adapted to the examination. For example, the examination of a head requires a different sequence of sub-programs EXAMPROG_SUB at the MR scanner SC than the examination of a breast.

For this purpose, at the terminal apparatus UT for the user processing workflow guidelines TEMPLATE are used that respectively combine or group specific sub-programs ITEM of the control and processing program SYNGO for the control of the sub-programs EXAMPROG_SUB at the MR scanner SC. By providing processing workflow guidelines TEMPLATE, the possibility is therefore achieved that individual sub-programs EXAMPROG_SUB are called up in a defined order and combination by the control and processing program SYNGO.

For example, a first processing workflow guideline TEMPLATE1 for the examination of a head can call up the scan programs EXAMPROG_SUB_{—}1, EXAMPROG_SUB_{—}2 and EXAMPROG_SUB_{—}3 of the MR scanner SC in succession. For this, the first processing workflow guideline comprises the individual referencing sub-programs ITEM_{—}1, ITEM_{—}2 and ITEM_{—}3 that are associated with the respective scan programs EXAMPROG_SUB_{—}1, EXAMPROG_SUB_{—}2 and EXAMPROG_SUB_{—}3.

Compared to this, a second processing workflow guideline TEMPLATE2 for the examination of a breast can successively call the scan programs EXAMPROG_SUB_{—}1, EXAMPROG_SUB_{—}2 and EXAMPROG_SUB_{—}4 of the MR scanner SC. For this, the second processing workflow guideline comprises the individual referencing sub-programs ITEM_{—}1, ITEM_{—}2 and ITEM_{—}4 that are associated with the respective scan programs EXAMPROG_SUB_{—}1, EXAMPROG_SUB_{—}2 and EXAMPROG_SUB_{—}4.

By selecting a processing workflow guideline TEMPLATE, a physician can achieve a best-suited control of the MR scanner SC for the respective examination. In the delivery state of the MR scanner SC, the processing workflow guidelines TEMPLATE are adapted to user-specific requirements and the original examination program EXAMPROG.

Via control and processing programs SYNGO with processing workflows TEMPLATE at the terminal apparatus UT, the possibility is provided to assist the radiologist in the efficient control and evaluation of many different scan types.

Examination data that are obtained from the respective sub-programs EXAMPROG _SUB of the MR scanner SC are automatically structured in specific views (layouts) that satisfy the radiological requirements of the specific scan.

If the examination data have been scanned by the MR scanner SC, an automatic association thus occurs, and the radiologist merely needs to click on the patient entry in the control and processing program in order to open the data in the respective view.

The examination data are processed according to the processing workflow guideline TEMPLATE that includes the corresponding views with the individual scan results (scan series).

With this measure, the radiologist can concentrate on the evaluation of the examination data instead of manually sorting the examination data for a comparison.

From time to time, it can be necessary to change or update the scan program EXAMPROG at the MR scanner SC in order to execute the newest and most advanced scan program EXAMPROG at said MR scanner SC. Updates normally comprise smaller improvements, for instance optimizations in the program execution speed, bug fixes or expansions of the examination program EXAMPROG with new functions EXAMPROG _SUB. For example, new pulse programs and control methods can be added.

Given a conventional update of the scan program EXAMPROG, however, no automatic adaptation is made to the control and processing program SYNGO at the terminal apparatus UT.

If an adaptation of the control and processing program SYNGO is conducted manually by a user (for example by a radiologist or a clinic administrator), the control and processing program SYNGO is adapted by hand to the new conditions at the MR scanner SC. This procedure often requires searching for new scan results from a long list with up to 50 articles, and establishment of an association.

This procedure is error-prone, time-intensive and results in less efficient processing workflows over the course of time. The use of the originally preset processing workflows TEMPLATE decreases since the control and processing at the terminal apparatus UT does not keep step with the modified scan program EXAMPROG.

In addition to this, users at the terminal apparatus are not informed that there has been a change in the scan program EXAMPROG of the MR scanner SC. Therefore, only that person who has modified the scan program EXAMPROG at the MR scanner SC can implement the update to the processing workflow guideline TEMPLATE at the terminal apparatus UT.

According to the invention, these disadvantages can be remedied in that an automatic adaptation of the control and processing program SYNGO to the terminal apparatus UT is made depending on an update information when the examination program EXAMPROG at the MR scanner SC is updated. Additionally, it can be indicated to a user at the terminal apparatus UT that new or updated sub-programs EXAMPROG_SUB are available at the MR scanner SC so that said user can make these (possibly necessary) additional manual adaptations.

Furthermore, at the MR scanner SC the possibility can be provided to the user to mark one or more of the sub-programs EXAMPROG_SUB as a standard program (DEFAULT) or non-standard program (NON-DEFAULT). For example, sub-programs EXAMPROG_SUB that are added to a scan program merely for research purposes can thereby be marked as non-standard programs (NON-DEFAULT) and remain unconsidered in an adaptation of the control and processing program SYNGO.

The updating of the scan program EXAMPROG at the MR scanner SC can be triggered, for example, by a user or administrator in that he calls up a specific update routine. The update information for the scan program EXAMPROG at the MR scanner SC can then be provided by a data medium (for example a CD or a USB memory) or be downloaded via a data network (the Internet, for example). In an alternative embodiment, the MR scanner SC connects to a server of the manufacturer via the network NW at regular intervals in order to check whether updates of the scan program EXAMPROG are present. If this is the case, the MR scanner SC downloads the update information from the server of the manufacturer and installs the updated scan program EXAMPROG at the MR scanner SC.

Given this update, individual sub-programs EXAMPROG_SUB of the scan program EXAMPROG can be modified, added, replaced or deleted.

The MR scanner SC can then automatically transmit information about the modified scan program EXAMPROG to the control and processing program SYNGO so that no additional user interaction is required to adapt the control and processing program SYNGO. The update information can include an updated processing workflow guideline TEMPLATE for the control and processing program SYNGO so that the updated processing workflow guideline TEMPLATE can be used immediately in the processing program SYNGO. The update information can additionally include an instruction to change the processing of the examination data at the terminal apparatus, or the display or a layout. In another embodiment, identification numbers or version numbers of sub-programs EXAMPROG_SUB of the MR scanner SC can be relayed to the terminal apparatus UT. In yet another embodiment, given an update of the examination program EXAMPROG at the MR scanner SC an installation program is transmitted from the MR scanner SC to the terminal apparatus UT, which installation program is called by the terminal apparatus UT after the transmission and provides for the adaptation of the control and processing program SYNGO.

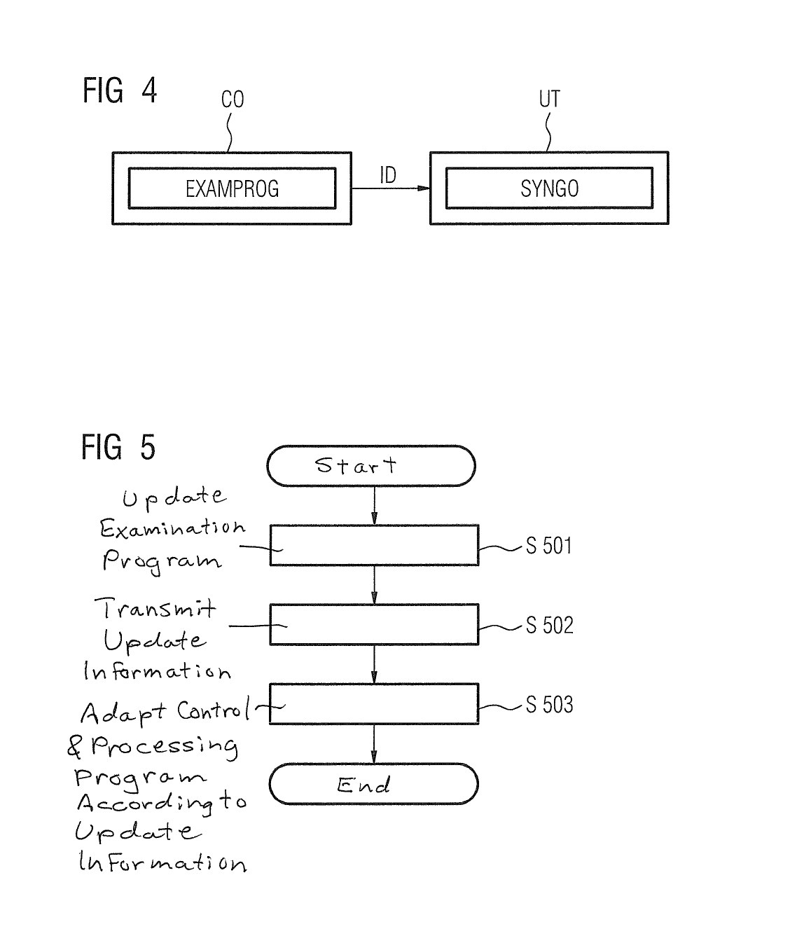

FIG. 4 schematically shows a transmission of update information between an MR scanner SC and the terminal apparatus UT. After an update of the scan program EXAMPROG at the MR scanner, a suitable update information ID is sent to the terminal apparatus UT.

The adaptation of the control and processing program SYNGO takes place depending on the update information received by the MR scanner.

For example, in this adaptation individual sub-programs ITEM of the control and processing program SYNGO can be modified, added, replaced or deleted. In addition to this, in the adaptation of the control and processing program SYNGO the association of sub-programs ITEMS with processing workflow guidelines can be modified.

For example, the adaptation of the control and processing program SYNGO takes place via the transmission of a complete installation program from the MR scanner SC to the terminal apparatus UT after the update of the scan program EXAMPROG. The installation program is executed at the terminal apparatus UT and makes the necessary changes and adjustments to the control and processing program. Furthermore, it is possible to transmit individual processing workflow guidelines TEMPLATE from the MR scanner SC to the terminal apparatus UT within the scope of the update. Moreover, it is possible to transmit only specific version or identification information for the scan program EXAMPROG or the sub-programs EXAMPROG_SUB. This version or identification information can then be transmitted to a server of the manufacturer that then provides a suitable adaptation for the control and processing program depending on the version or identification information.

For example, given an update of the scan program an additional sub-program EXAMPROG_SUB_N+1 can be added to the scan program EXAMPROG at the MR scanner SC.

Before an update, the control and processing program SYNGO comprises the processing workflow guideline for examination of a head with the sub-programs ITEM_{—}1, ITEM_{—}2 and ITEM_{—}3. After the update, a unique identification information ID for the newly added sub-program EXAMPROG_SUB_N+1 is transmitted to the terminal apparatus UT.

The identification information ID, together with a version information of the control and processing program SYNGO, is transmitted from the terminal apparatus UT to the server of the manufacturer, for example. The server checks the information and provides an adaptation routine for the control and processing program for download.

After the adaptation, the control and processing program SYNGO comprises the processing workflow guideline TEMPLATE for examination of a head with the sub-programs ITEM_{—}1, ITEM_{—}2, ITEM_{—}3 and ITEM_N+1. The sub-program ITEM_N+1 serves to control the newly installed sub-program EXAMPROG_SUB_N+1 at the MR scanner SC.

Through an additional, automatic adaptation of a visualization of the examination results depending on a modified scan program EXAMPROG, an optimal presentation of the examination results is provided to the user.

FIG. 5 shows a block diagram for the adaptation of a control and processing program.

First, in Step S501 an update of the examination program EXAMPROG is conducted. In Step S502, a suitable update information is subsequently transmitted to the terminal apparatus UT, using which update information the update of the examination program EXAMPROG can be determined directly or indirectly. In Step S503, an adaptation of the control and processing program SYNGO is subsequently conducted using the update information.

According to the invention, a communication of modified scan programs EXAMPROG from the MR scanner SC to the control and processing program is therefore made, in the scope of which an automatic update of the processing workflow guidelines TEMPLATE in the control and processing program SYNGO that relate to the modified scan program EXAMPROG is executed, for example.

The update information is available in the control and processing program SYNGO, for example in order to display this to a user.

The following advantages are achieved by the invention:

Reduction of a cost to adapt processing workflow guidelines of the control and processing program.

Time savings for an administrator, since information about the modified examination program is provided automatically, and the adaptation of the control and processing program occurs automatically.

Improved quality of the processing workflows and better presentation of examination results since all examination data, views or layouts remain correctly structured.

Continuously high value of processing workflow guidelines at the terminal apparatus since these remain in synchronization with the newest scan programs at the MR scanner.

Additional information of [sic] the clinic administrator about modified scan programs and the necessity to mark the respective changes in the processing workflow guidelines, independent of personal communication, and therefore with increased reliability.

Although modifications and changes may be suggested by those skilled in the art, it is the intention of the inventor to embody within the patent warranted hereon all changes and modifications as reasonably and properly come within the scope of her contribution to the art.

I claim as my invention:

1. A method to automatically update a control and processing program at a terminal apparatus that processes examination information obtained by a medical examination apparatus and to control an examination program at the medical examination apparatus, comprising:
in a computerized processor at a medical examination apparatus, updating an examination program that is used to operate the medical examination apparatus to acquire examination information;
transmitting update information, describing updating of the examination program, from the processor of the examination apparatus to the terminal apparatus; and
at said terminal apparatus, adapting said control and processing program dependent on said update information.

2. A method as claimed in claim 1 wherein said examination program comprises multiple sub-programs, and comprising updating the examination program by at least one of updating a sub-program among said multiple sub-programs of said examination program dependent on said update information, removing a sub-program among said multiple sub-programs of said examination program dependent on said update information, and adding a sub-program to said examination program dependent on said update information.

3. A method as claimed in claim 2 comprising associating unique identification information with each of said sub-programs, and comprising transmitting said update information including transmitting said identification information.

4. A method as claimed in claim 1 wherein said control and processing program comprises multiple sub-programs that are associated with a processing workflow guideline, and comprising adapting said control and processing program by at least one of updating a sub-program among said multiple sub-programs of said control and processing program dependent on said update information, removing a sub-program among said multiple sub-programs of said control and processing program dependent on said update information, and adding a sub-program to said processing workflow guideline dependent on said update information.

5. A method as claimed in claim 4 wherein said examination program comprises multiple sub-programs, and comprising updating the examination program by at least one of updating a sub-program among said multiple sub-programs of said examination program dependent on said update information, removing a sub-program among said multiple sub-programs of said examination program dependent on said update information, and adding a sub-program to said examination program dependent on said update information.

6. A method as claimed in claim 5 comprising storing a predetermined association between at least one sub-program of said examination program and at least one sub-program of said control and processing program.

7. A method as claimed in claim 1 comprising adapting a display program at said terminal apparatus dependent on said update information.

8. A method as claimed in claim 1 wherein said examination program comprises multiple sub-programs, and comprising updating the examination program by at least one of updating a sub-program among said multiple sub-programs of said examination program dependent on said update information, removing a sub-program among said multiple sub-programs of said examination program dependent on said update information, and adding a sub-program to said examination program dependent on said update information, and wherein said method further comprises labeling at least one sub-program of said examination program as a standard sub-program.

9. A method as claimed in claim 8 comprising transmitting said update information for the sub-program labeled as a standard sub-program to said terminal apparatus.

10. A medical examination system to automatically update a control and processing program at a terminal apparatus that processes examination information obtained by a medical examination apparatus and to control an examination program at the medical examination apparatus, comprising:
a computerized processor at a medical data acquisition apparatus, configured to update an examination program that is used to operate the medical data acquisition apparatus to acquire examination information;
said processor being configured to transmit update information, describing updating of the examination program, from the processor to the terminal apparatus; and
said terminal apparatus being configured to adapt said control and processing program dependent on said update information.

11. A non-transitory, computer-readable data storage medium encoded with programming instructions, said data storage medium being loaded in a distributed manner in a computerized processor of a medical examination apparatus operable by said processor to obtain examination information according to an examination program, and a terminal apparatus in communication with said processor that processes said examination information according to a control and processing program, said programming instructions causing said processor and said terminal apparatus to:
at said computerized processor, update an examination program that is used to operate the medical examination apparatus to acquire examination information;
transmit update information, describing updating of the examination program, from the processor of the examination apparatus to the terminal apparatus; and
at said terminal apparatus, adapt said control and processing program dependent on said update information.
